(19) United States
(12) Patent Application Publication
(10) Pub. No.: US 2003/0154831 A1
(43) Pub. Date: Aug. 21, 2003

(54) AUTOMATIC SCREW MACHINE HAVING ELECTRONICALLY CONTROLLED FUNCTIONS

(76) Inventors: Florian I. Nowak, Newington, CT (US); Jay P. Giblin, Cheshire, CT (US)

Correspondence Address: Ira S. Dorman, LAW OFFICE OF, IRA S. DORMAN, 330 ROBERTS STREET, SUITE 200, EAST HARTFORD, CT, 06108, US

(21) Appl. No.: 10/077,433

(22) Filed: Feb. 15, 2002

(51) Int. Cl. B23B 9/00; B23B 25/06

(52) U.S. Cl. 82/129; 82/133

(57) ABSTRACT

Sensors are incorporated into a multiple spindle automatic screw machine in such manner as to effectively monitor burring spindle retraction and stock supply and feeding. The lubricant/coolant level sensor is housed in a protective auxiliary chamber, and adaptations to the threading axis drive, the work spindle axis drive, and the cam axis drive improve performance of the machine while at the same time reducing its complexity.

### BACKGROUND OF THE INVENTION

Sensors for generating control signals are widely used to monitor various functions of automatic machines. Among the purposes for doing so are included the enhancement of safety and the increase of productivity.

In automatic screw machines, for example, safe cycle transitions require assurance that the revolving head is not constrained against free indexing, and maximum productivity requires assurance that sufficient workpiece stock is always available to the machine during operation and is being properly fed to the work station. Optimal control of the several machining functions, moreover, often relies upon the availability of accurate speed and position information, coupled with the ability to closely and independently change parameters (e.g., to vary the speed of a threading spindle independently of that of a feed spindle).

The five-spindle automatic screw machine that is commercially available from the Davenport Machine Tool Co., Inc., of Rochester, N.Y., is in widespread use and incorporates certain sensor-based feedback control functions. Nevertheless, modifications that increase safety and operating efficiency of such machines are of course highly desirable, especially if they are made without compromising advantageous features of the machine and without adding substantially to its size (and, in particular, its footprint) or complexity.

### SUMMARY OF THE INVENTION

Accordingly, a broad object of the present invention is to provide novel sensor arrangements by which the safety of operation and the productivity of an automatic machine, and in particular an automatic multiple spindle screw machine, can be enhanced and increased.

More specific objects of the invention are to provide such sensor arrangements which function to ensure safe indexing of the revolving head of a multiple spindle automatic screw machine, to maximize productivity by monitoring workpiece stock loading and operation of feed mechanisms, and to ensure that adequate levels of the coolant/lubricant liquid are maintained.

Other broad objects of the invention are to provide novel axis drive adaptations in multiple spindle automatic screw machines, and in particular to provide threading axis drive, work spindle axis drive, and cam axis drive adaptations therein.

A typical multiple spindle automatic screw machine, having electronically controlled functions, will include: a frame; electronic control means (generally in the form of digital electronic data processing means, albeit analog controls may also be employed); a revolving head having work spindles, and a stationary head; a burring spindle mounted for axial reciprocation in the stationary head for removing shaped parts from the work spindles; feed tubes in the revolving head; means for advancing stock through the feed tubes, including a reciprocating chuck slide, a chuck slide opening guide pivotably mounted for movement between positions engaged with and disengaged from the chuck slide, and a chuck slide opening cam lever disposed adjacent the chuck slide opening guide; and a tank for containing a reservoir of liquid, defined by a lateral wall of the machine.

It has now been found that certain of the foregoing and related objects of the invention are attained by the provision of improvements in such a machine, comprising, alone and in various combinations:

a first sensor operatively mounted on the frame of the machine adjacent the burring spindle for movement throughout a range of selectively fixed positions therealong, the first sensor being constructed for generating a first signal indicative of the proximity of an activating element and being operatively connected for transmitting the first signal to the electronic control means; and an activating element disposed on the burring spindle at such a location as to enable it to come into activating proximity to the first sensor, disposed in an effective position, immediately upon retraction of the burring spindle from a forward position adjacent a work spindle in the revolving head, such that the first signal indicates that the revolving head can safely be indexed;

a second sensor mounted upon either the chuck slide opening guide or the chuck slide opening cam lever of the stock advancing means, and being constructed and positioned for generating a second signal indicative of the proximity of the other of those two components, the second sensor being operatively connected for transmitting the second signal to the electronic control means, for indicating that stock is being advanced through the feed tubes;

a third sensor operatively mounted upon the frame of the machine, adjacent intake ends of the feed tubes, and being constructed and positioned for generating a third signal indicative of the presence of stock extending from the feed tube intake ends, the third sensor being operatively connected for transmitting the third signal to the electronic control means, for indicating that stock is becoming exhausted in the feed tubes;

alarm means responsive to the second signal and/or the third signal; and

an outwardly disposed extension in liquid flow communication with the tank through a lateral wall of the machine, and defining an auxiliary chamber of small volume; and a liquid level sensor disposed within the auxiliary chamber, entirely outwardly of the lateral wall, the liquid level sensor being constructed for generating a fourth signal indicative of the depletion of liquid in the tank.

In certain preferred embodiments the “first” sensor (used for detecting the initiation of burring spindle retraction) will function magnetically, and the activating element, constructed to induce current flow in the sensor, will comprise a ring of ferromagnetic material operatively affixed coaxially on the burring spindle in surrounding relationship thereto. The burring spindle will normally have a gear affixed coaxially thereon for receiving driving power for effecting rotation thereof, and the activating ring will normally have a well-defined circumferential edge and will advantageously be affixed directly to the driven gear with its circumferential edge disposed forwardly thereof for magnetic interaction with the sensor. The machine will preferably include a way, affixed on its frame and defining a track that extends adjacent to the burring spindle and parallel to its axis, and a saddle mounted upon the way for slidable movement along the track, the saddle carrying the sensor and having means thereon for affixing it in any selected position along the way. The sensor will most desirably include an associated visual indicator for indicating when the sensor is activated by the activating element and to thereby facilitate the determination of an effective position for the sensor.

In other preferred embodiments the “second” sensor (used for detecting a non-feed condition) is mounted upon the chuck slide opening cam lever, which will have a surface that lies in face-to-face contact with a mating surface of the chuck slide opening guide when the latter is in its position of engagement with the chuck slide. The sensor will have a functional end lying substantially on the surface of the chuck slide opening cam lever, and will serve to sense the proximity of the mating surface of the chuck slide opening guide; it will usually function magnetically, with the mating surface of the chuck slide opening guide serving to induce current flow therein.

The sensor employed for indicating stock depletion and exhaustion will usually be an optical sensor. In such an embodiment the electronic control means will most advantageously be constructed (programmed) to enable the determination of decrementation values, to thereby indicate an exhausted stock condition based upon input stock length and utilization data, and machine feed requirements. In especially preferred embodiments the stock-depletion sensor will be used in combination with the non-feed sensor in such manner that the determination of decrementation values will be effected only when the proximity-indicating signal from the non-feed sensor indicates that stock is being advanced through the feed tubes. Alarm means will desirably be operatively connected to the electronic control means, which control means will, in such instances, be constructed to activate the alarm means when the proximity-indicating signal and/or the stock presence-indicating signal indicates that stock is not being advanced through the feed tubes and that stock in at least one of the feed tubes has become exhausted, respectively. The liquid level sensor will desirably also be operatively connected for transmitting liquid-depletion signals to the electronic control means, which signals may also serve to activate alarm means provided.

### BRIEF DESCRIPTION OF THE DRAWINGS

FIGS. 1 and 2 are perspective views, taken from opposite sides, of a modified five-spindle automatic screw machine embodying the present invention;

FIG. 3 is a fragmentary perspective view of the work station of the machine of FIGS. 1 and 2, drawn to a scale enlarged therefrom.

FIGS. 4 and 5 are fragmentary elevational views, taken along line 4-4 of FIG. 3 and drawn to a further enlarged scale, depicting a portion of the burring spindle of the machine and a position sensor utilized therewith;

FIG. 6 is a fragmentary perspective view of an operator-controlled stock-feed station of the machine, depicting components that serve to control and actuate the collets of the feed spindles;

FIGS. 7 and 8 are fragmentary views, in partial section, taken generally along line 7-7 of FIG. 6 and showing, in FIG. 7, the components in engaged relationship for feeding stock and, in FIG. 8, the components in disengaged relationship;

FIG. 9 is a fragmentary perspective view showing the stock loading location of the machine;

FIGS. 10 through 12 are end, plan, and side elevational views of an optical sensor used to determine the presence of stock protruding from the intake ends of the feed tubes of the machine;

FIG. 13 is a fragmentary perspective view showing the lubricant/coolant tank of the machine, with an auxiliary chamber containing a liquid level sensor;

FIG. 14 is a sectional view taken along line 14-14 of FIG. 13;

FIG. 15 is a fragmentary perspective view showing the stationary head of the machine, with an added servomotor arranged for operating a threading spindle;

FIG. 16 is a fragmentary rear elevational view of the stationary head and servomotor depicted in FIG. 15;

FIG. 17 is a fragmentary perspective view showing a gear train section of the machine, including torque-modifying change gears;

FIG. 18 is a fragmentary elevational view of the section of the machine shown in FIG. 17;

FIG. 19 is a sectional view, taken along line 19-19 in FIG. 1, diagrammatically showing a hollow shaft encoder mounted upon the main drive shaft of the machine;

FIG. 20 is a view taken along line 20-20 of FIG. 19, showing one side of the encoder;

FIG. 21 is a fragmentary perspective view of cam axis drive features utilized in the machine of the invention;

FIG. 22 is an elevational view of the gear box casting of the machine, drawn to a scale enlarged from that of FIG. 21 and showing components substituted for conventional ones;

FIG. 23 is a fragmentary perspective view showing an encoder coupled to a shaft in the cam system depicted in FIGS. 21 and 22, attached to an adjustable mounting plate;

FIG. 24 is a fragmentary perspective view, taken from a position inwardly of the machine, showing additional details of the encoder mounting arrangement; and

FIG. 25 is an elevational view of the encoder and mounting arrangement, and the cam axis drive coupling.

### DETAILED DESCRIPTION OF THE ILLUSTRATED EMBODIMENTS

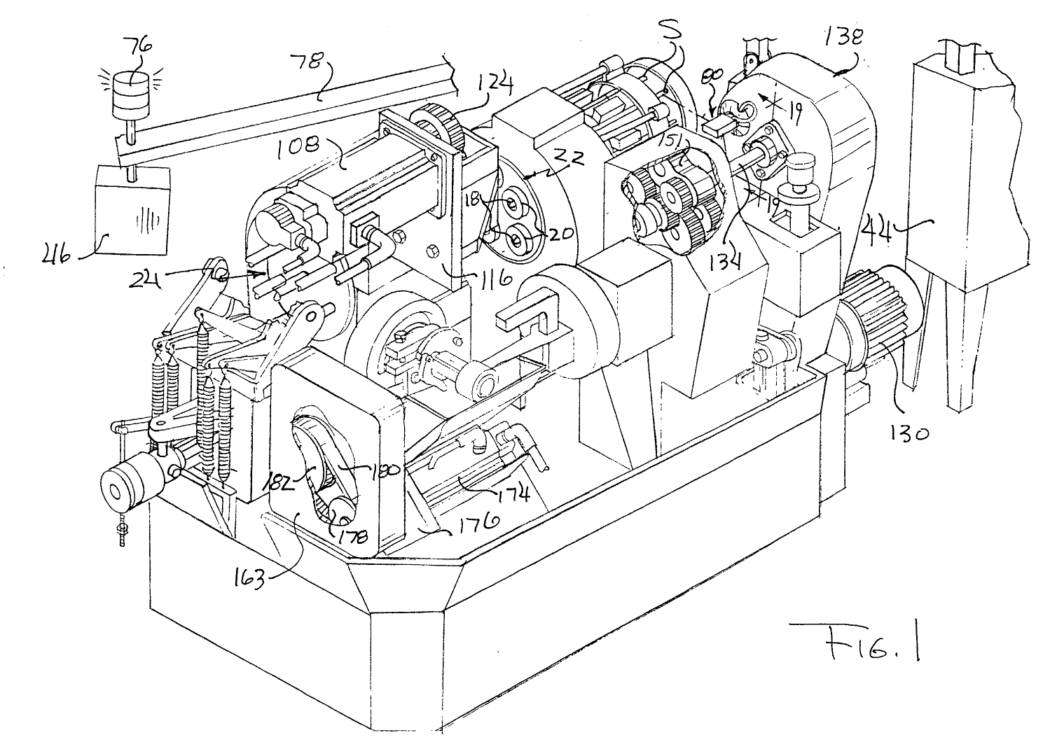

Turning initially to FIGS. 1 through 5 of the drawings in greater detail, therein illustrated is the work station of a five spindle automatic screw machine, including its revolving and stationary heads, generally designated by the numerals 22 and 24, respectively. As will be appreciated, it is at this station that forming operations are carried out on the workpiece (e.g., rod stock “S”), which may entail not only thread-cutting operations but also secondary operations such as milling, cross-drilling, cross-tapping, slotting, etc. Rod stock S is of course fed through feed tubes contained in each of the five spindles of the revolving head, and is secured in each incrementally advanced position by the associated collet 18.

Each part must of course be cut-off from the feedstock and withdrawn after it has been shaped. For that purpose the burring (pick-off) spindle 10 has a collet 12 on its forward end for gripping the part; an affixed gear 14 is operatively coupled to the center drive 16 for rotating the spindle 10, and it is reciprocated in the stationary head 24 (by means not shown).

If for any reason (e.g., cut-off tool failure) the burring spindle 10 does not retract in properly timed sequence, it is imperative that the condition be detected immediately and that the machine be stopped prior indexing of the revolving head, following initiation of the next cycle. Otherwise, permanent damage to the machine and/or to the tooling will likely result.

In accordance with the present invention, a sensor, generally designated by the numeral 26, is closely integrated for detection of the initiation of burring spindle retraction. The sensor 26 consists of a saddle 28, which mounts a small, solid-state, non-contact D.C. inductive proximity switch 30, secured by a clamp plate 32 which is in turn fastened to the saddle 28 by screw 33; suitable such switches are available commercially from Balluff, Inc., of Madison, Conn., under the designation BES-516-3046-G-E4-L-PU-05, which has a rated operating distance of 0.04 inch. The switch 30 serves to sense a proximate metallic element, which magnetically induces a current that not only provides the necessary control signal but also activates an LED 34, which is visible through a small aperture 36 in the clamp plate 32; alternatively, sensors that function optically, and perhaps by ultrasound as well, might also be employed. A metal ring 38 is welded to the driven gear 14 and provides the element by which the signal is induced in switch 30, with the well-defined circumferential forward edge of the ring 38 effectively producing a clear, strong impulse. The saddle 28 of the sensor 26 is slidably mounted upon a box way 42, and can be affixed in any selected position along the length of the way by tightening of set screw 40.

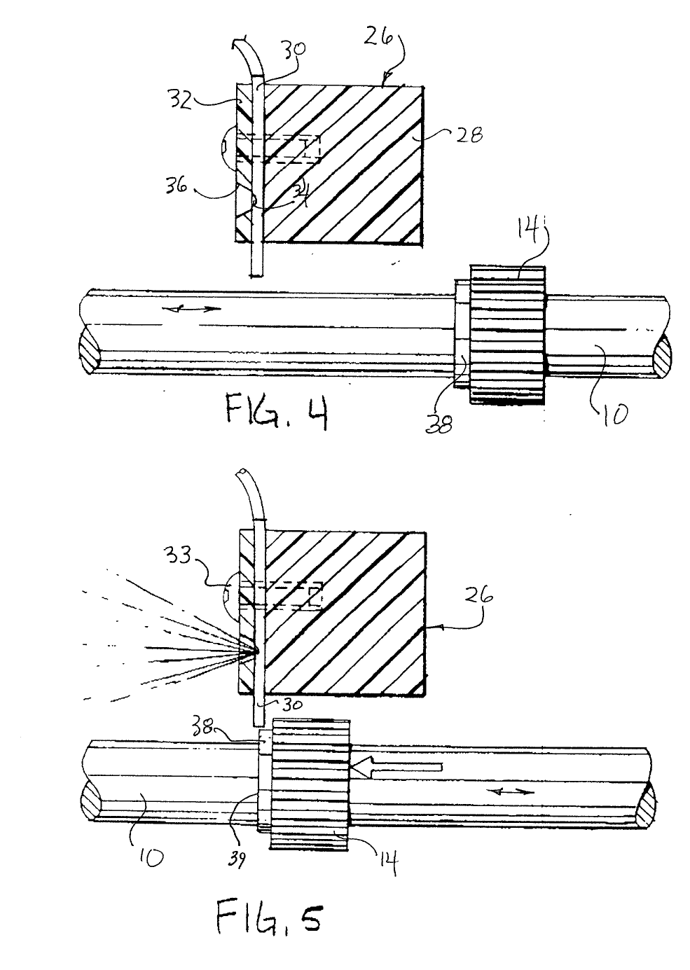

The sensor is positioned during the machine set-up procedure. With the burring spindle 10 in its fully extended, forward position (proximate a work spindle of the revolving head 22), the sensor 26 is moved on the way 48 until the functional end of the switch 30 is disposed directly over the edge 39 of the ring 38, as depicted in FIG. 5. Provided the switch 30 is functioning properly, a signal current will thereby be generated, illuminating the LED 34 and thus informing the operator that the sensor is properly positioned; the set screw 40 would then of course be tightened. The signal generated is also transmitted to digital electronic data processing means, contained in the cabinet of a controller 44, and is visually confirmed on the monitor 46 which is supported over the operator station by the pendant arm 78 on the cabinet 44.

It should be noted that, in cycle operation, the states of the switch 30 are polled in both the spindle forward (fully extended) and also the spindle retracted (fully withdrawn) positions so as to permit the controller to ensure that the switch is operating correctly. Specifically, the controller routine would poll the switch to ensure that it is transitioning correctly from the made (on) position, with the spindle extended, to the unmade (off) position with the spindle retracted; two checks are made during the retraction phase, i.e., both upon initiation of movement and also immediately prior to insertion of the machining tools. It should also be appreciated that the sensor system must be capable of high-speed operation, typically generating a signal in less than 0.09 of a cycle; such immediate response is necessary to ensure sufficient time for stopping the machine if there is any indication that initial movement of the spindle, in retraction, has not occurred.

The stock chucking operations that take place in automatic screw machines can be disabled manually by the operator; when that occurs no stock is fed and, of course, no parts are produced. To maximize productivity, therefore, it is desirable that the controller be able to determine, during the machine cycle, the status of the mechanical components that are employed in the work chucking and unchucking operations. More particularly, knowing the positions of the chuck opening cam lever and its appendages, the chuck slide opening guide latch, and the chuck slide roller opening guide allows necessary inferences to be drawn about the feed status of the machine.

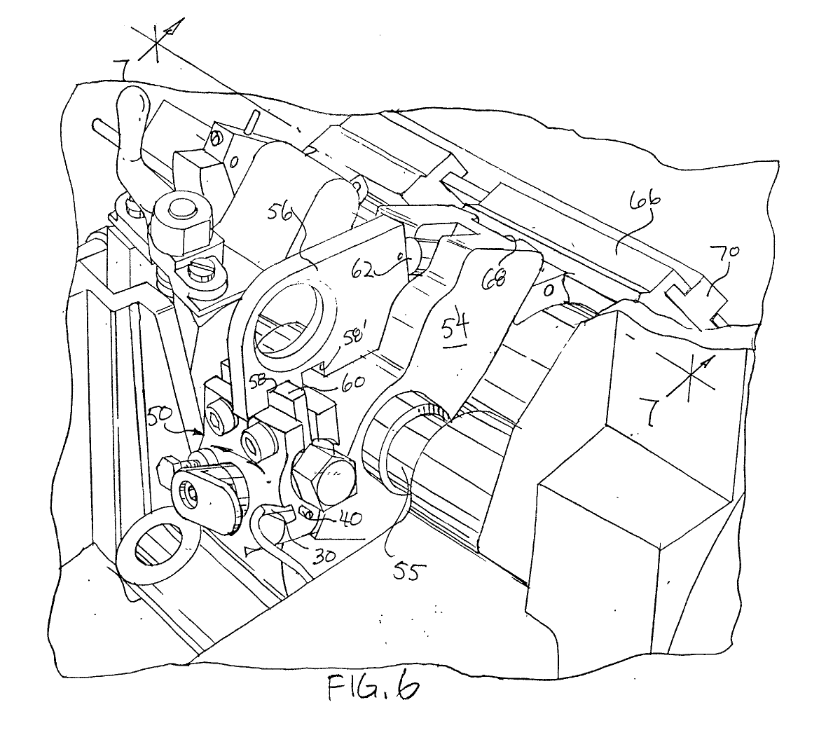

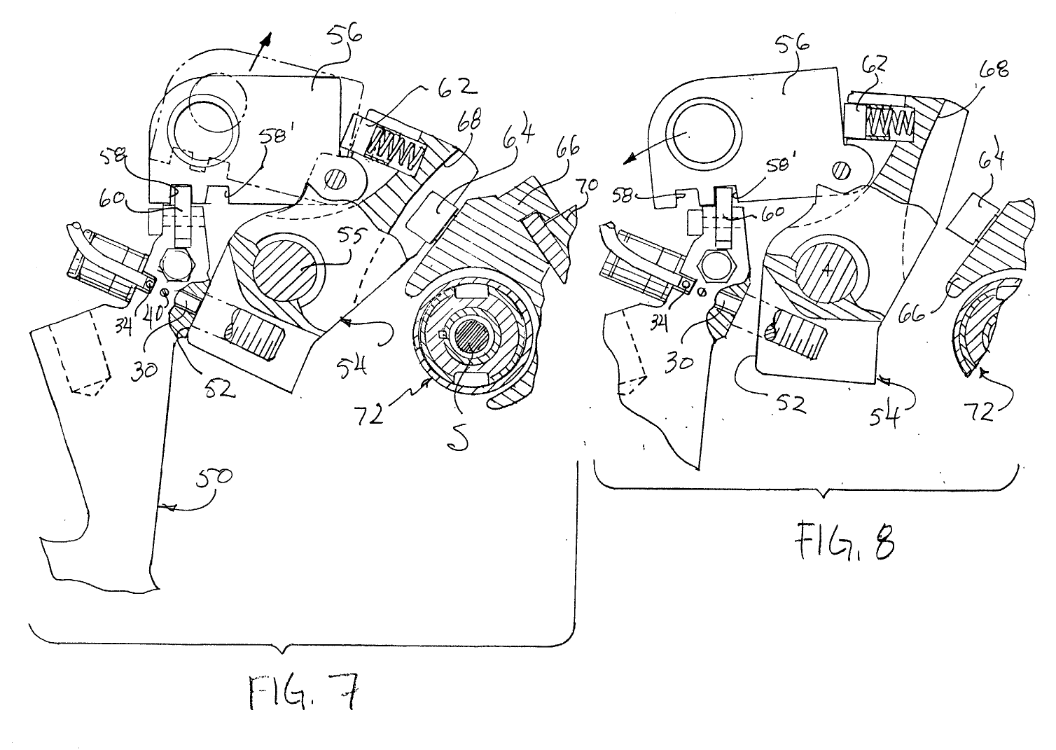

A novel solution to the problem of inappropriate disabling of stock feed functions is thus afforded by the installation of a sensor for detecting the relative positions of the chuck opening cam lever and the chuck slide roller opening guide. More particularly, and with specific reference to FIGS. 6 through 8 of the drawings, a second solid-state non-contact proximity switch 30, as hereinabove described, is affixed in a small passage formed in the upper portion of the chuck slide opening cam lever, generally designated by the numeral 50; the lever 50 is mounted (by means not shown) to pivot from side-to-side, as indicated by the double-headed arrow in FIG. 6. The switch 30 senses the proximity of the facing surface 52 of the chuck slide roller opening guide, generally designated by the numeral 54, to generate a signal when the cam lever 50 and the opening guide 54 are in their closed relationship (depicted in FIG. 7); the generated signal is conducted to the controller 44.

As can be seen, the closed position of the components is established when the fastening plate 60, attached to the chuck slide opening cam lever 50, is seated in the forward notch 58 of the latch 56 on the chuck slide roller opening guide 54. In that relationship the roller 64 on the chuck slide 66 is engaged in the slot 68 of the opening guide 54, such that sliding movement of the guide on the rod 55, effected by rotation of the opening cam lever 50, causes the chuck slide 66 to reciprocate on the rail 70 which, in turn, causes the rod stock S to advance within the feed tube assembly, generally designated by the numeral 72. Needless to say, when the latch 56 is shifted to cause the fastening plate 60 to seat in the rearward notch 58′, the roller 64 is disengaged from the slot 68 and no advancement of stock can occur. It will be appreciated that the spring-loaded contact element 62 serves to maintain the latch 56 in either selected position.

In the event the feed mechanism is disabled during normal operation of the machine, the absence of a signal generated in the switch 30, due to the remoteness of the surface 52, can serve to activate an alarm. For that purpose an audible annunciator 74 may be provided in the control cabinet 44, a and/or stack light 76 may conveniently be mounted above the operator control station monitor 46 on the pendant arm 78.

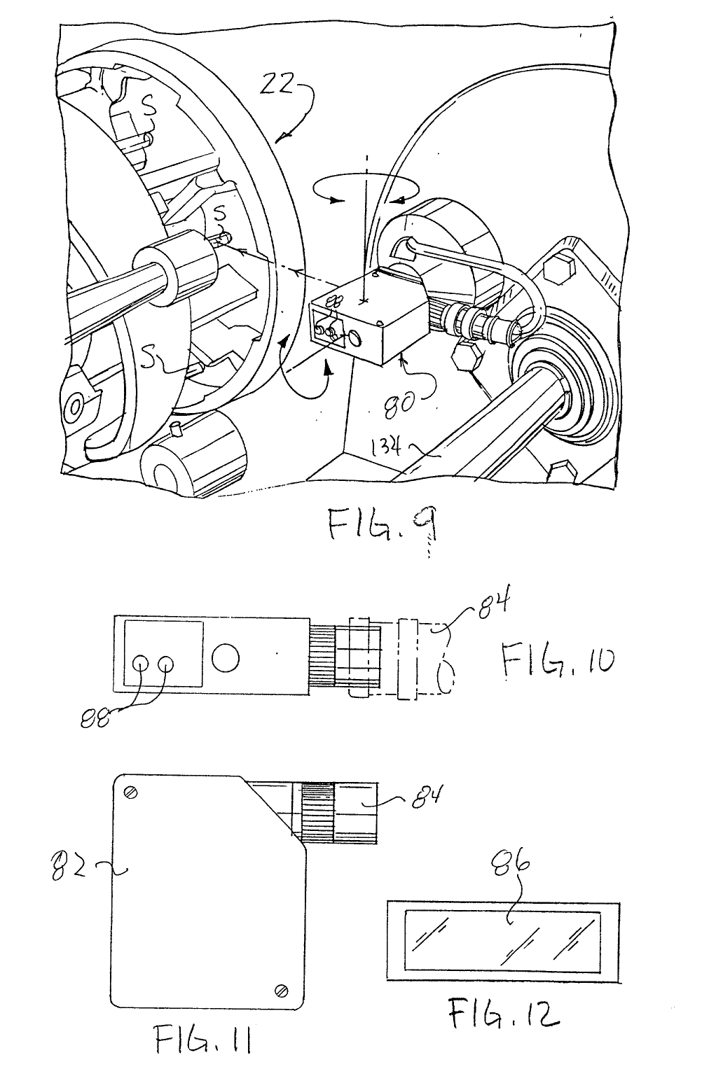

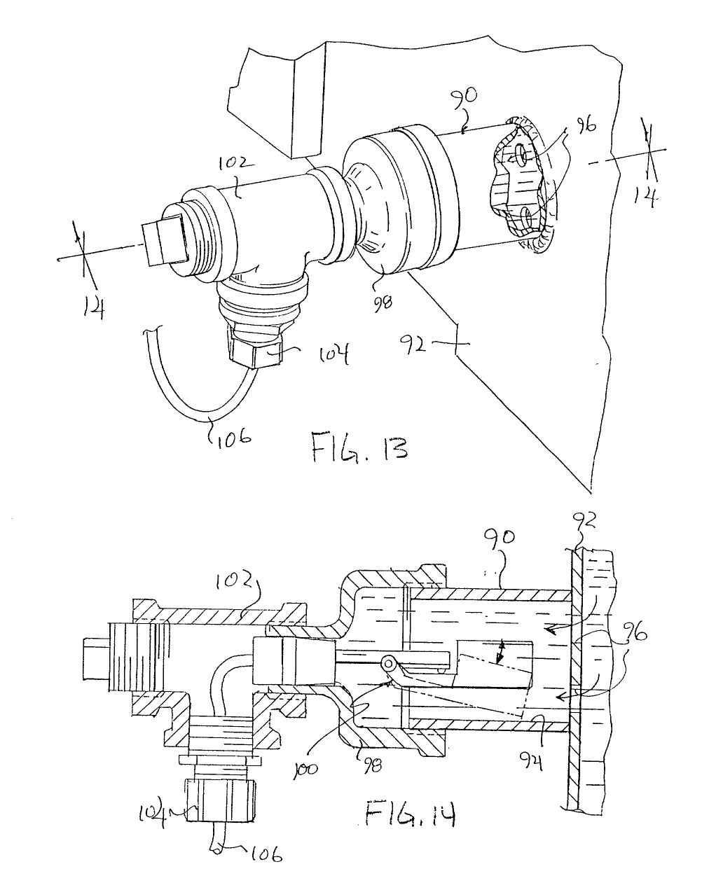

A related modification to the machine is specifically illustrated in FIGS. 9 through 12, and concerns the provision of a remotely located, non-contact optical sensor for detecting stock depletion and, coupled with the controller 44, to ultimately determine an out-of-stock condition. The sensor, generally designated by the numeral 80, is so located as to avoid interference with any existing machine attachments or operator maintenance procedures, and serves essentially to detect the existence of protruding stock from the intake end of each feed tube as the revolving head indexes from position to position.

An LED-based linear displacement sensor suitable for this application is available from Banner Engineering Corporation, of Minneapolis, Minn., under the manufacturer's number Q50BNYQ, and comprises a housing 82 and a cable coupling 84, the housing having a window 86 on one side, which is transparent to the radiation involved, and programming buttons 88 on an adjacent side. As indicated in FIG. 9, the sensor is adjustable about vertical and horizontal axes, so as to enable it to be accurately aimed to bring the ends of the feed tubes within its field of detection in each indexed position of the head 22.

When the sensor 80 detects the absence of stock protruding from the end of any feed tube, a signal is conducted to the controller 44, which is programmed to determine when the length of stock remaining is insufficient to permit feeding and the production of an additional part; i.e., the calculation takes into account the length of stock needed for the part (together with any wasted material), as well as the remnant length needed for feeding. When the stock is so depleted that no additional part can be produced, the controller generates an alarm signal and also stops the machine cycle in an orderly fashion, alerting the operator of the need to clear the fault and replenish the stock supply.

It will be appreciated that the sensor 80 operates in coordination with the controller 44 to monitor all five spindles in succession, and that an out-of-stock condition in respect of any single spindle will initiate of the alarm routine. It will also be appreciated that the sensor 80 best operates in conjunction with the sensor arrangement of the embodiment of FIGS. 6 through 8, which serves to confirm feeding of stock. Needless to say, if the controller has received a signal that stock is not being fed the decrementation routine described, as initiated by a signal from sensor 80, will not proceed.

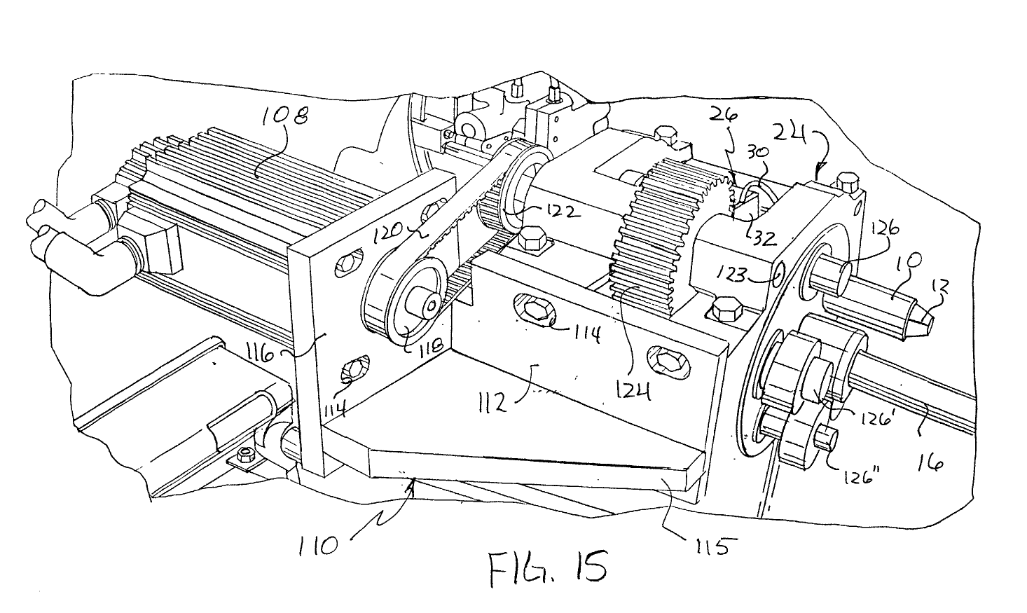

An additional sensor-related modification to the conventional Davenport automatic screw machine is depicted in FIGS. 13 and 14. To ensure that an adequate supply of coolant/lubricant is maintained for application to the shaping tools and to surfaces of moving parts, it is conventional to include a level sensor mounted on one of the sidewalls of the coolant/lubricant tank. Routine maintenance of the tank normally involves the use of crude, manual tools (so-called “chip hoes”) for the purpose of removing from the tank walls deposits of materials accumulated from the metal-shaping operations. This exposes the sensor to damage from impact by the cleaning tools, which are typically handled rather roughly and carelessly by the maintenance people.

In accordance with the present invention, a small cylindrical extension, or nipple, 90 is welded to a tank-defining wall 92 at the base of the machine. The nipple 90 defines a supplemental chamber 94, which is in fluid-flow communication with the tank through two, vertically-spaced holes 96 formed in wall 92. A reducing coupling 98 is threaded upon the outer end of the nipple 90, and serves for mounting a float switch, generally designated by the numeral 100 (a suitable switch for this purpose is commercially available from Gems Sensors, of Plainville, Conn., as its LS-7 series). A strain-relief connector 104 is engaged in one of the free openings of the Tee 102 (the remaining opening being plugged), and a cable 106 connects the sensor 100 to the controller 44. As is self-evident, when the liquid in the tank falls below a certain level the electrical contacts of switch 100 open, signalling the need to replenish the supply of coolant/lubricant.

Being contained within the nipple 90, the delicate sensor 100 is of course protected against physical impact and damage. It will be appreciated that more than two holes may be provided, is so desired, as long as free liquid flow is enabled and no air pocket that might interfere with accurate measurement can form; indeed, a single large hole, covered with a heavy mesh screen or otherwise protected against the entry of a cleaning tool, can be used.

In operation of an automatic screw machine, the stock from which the parts are shaped is rotated in each of the work spindles of the revolving head, while tools for producing threads, or for performing other cutting operations are rotated and translated by the spindles of the stationary head. As is well known, the work spindles and the threading spindles must be capable of rotating and translating at different, independently variable (but synchronous) speeds during threading in and threading out phases (and often during analogous phases of other operations); such controlled variability is also necessary to accommodate different materials, thread pitch variation, cycle times, etc.

In the conventional Davenport automatic screw machine, variations in spindle rotation and translation speeds are accomplished wholly by mechanical means (i.e., through clutches, gearing, cam and cam lever actuation, etc.), and the main drive motor supplies all of the energy required for the entire machine. This arrangement is complicated and expensive to implement, and it requires many moving parts and a great deal of maintenance.

In accordance with the present invention, the rotational aspect of the stationary head spindles of an automatic screw machine are modified while, at the same time, the basic operations of the revolving and stationary heads are retained, together with their attendant proven simplicity and reliability. By virtue of the threading axis drive adaption described, the spindles that are conventionally driven by complicated, cam-mechanical mechanisms are now driven electromechanically and are subject to the supervision of the machine controller; the threading processes are easier to control, and the results are more predictable, from machine to machine.

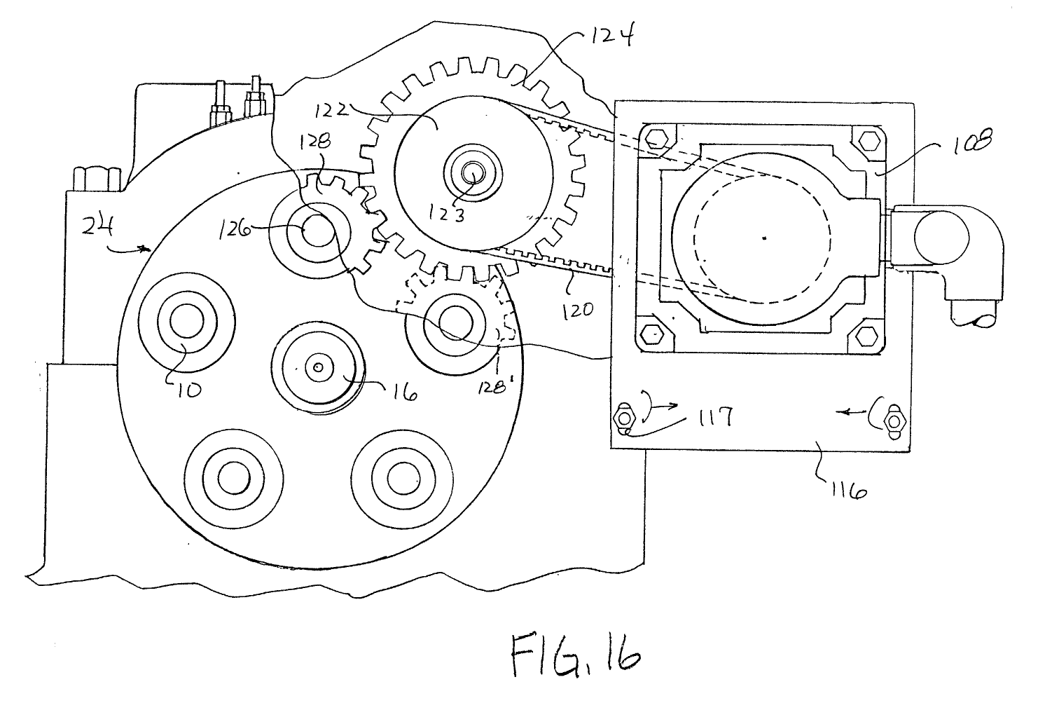

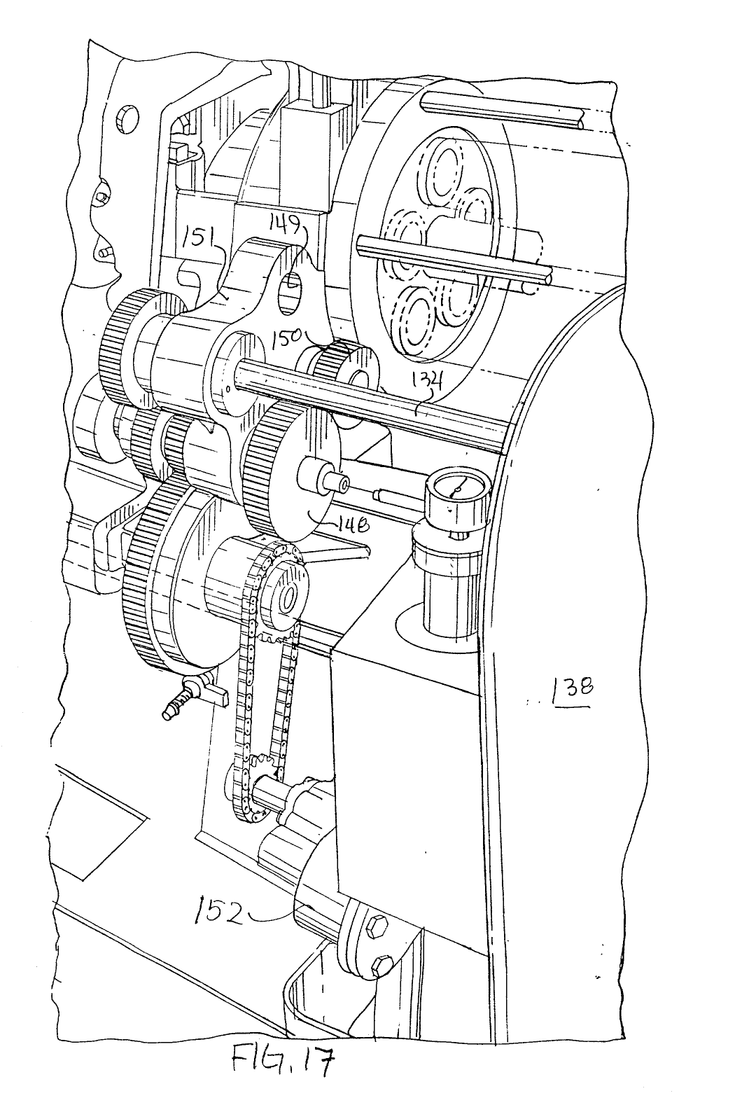

More particularly, and as can be seen in FIGS. 15 and 16, a bracket, generally designated by the numeral 110, includes a longitudinally extending vertical wall 112 having slotted openings 114 for receiving mounting bolts on which the position of the bracket can be adjusted from front to back on stationary head frame structure. A second vertical wall 116, disposed perpendicular to the wall 112, has similar slotted openings 114 for mounting a servomotor 108, which thus allow transverse adjustment; the added servomotor is positioned substantially within the space that would otherwise be occupied by the threading attachment of a conventional machine. As can be seen in FIG. 16, the wall 116 is also provided with vertically oriented slotted openings 117, thereby affording vertical adjustability of the wall 116 on the web 115 affixed to the wall 112, and hence of the servomotor 108.

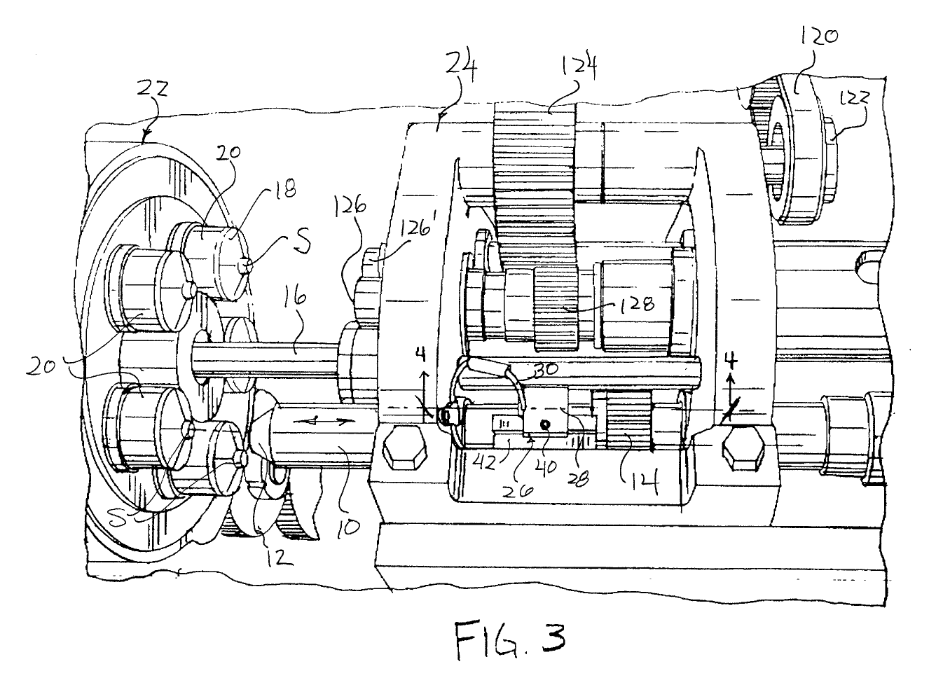

A cog tooth pulley 118 is attached to the shaft of the motor 108, and serves to drive pulley 122 through the belt 120, which latter pulley is affixed on shaft 123, to which the threading spindle drive gear 124 is also attached. As is seen in FIGS. 3 and 16, the drive gear 124 is in meshing engagement with the driven gear 128 on the threading spindle 126, thereby serving to effect its rotation at a speed that is determined by the controller 44, acting through the servomotor 108. As will be appreciated, the gear 124 can alternatively be brought into meshing engagement with the driven gear 128, on a second spindle 126′, which can be utilized for threading or other purposes. A third spindle 126″, which can also function as a threading spindle, would generally be brought into operative engagement with the drive gear 124 through an interposed idler gear (not shown).

In accordance with another modification to the conventional Davenport automatic screw machine, a work spindle axis drive adaptation is made which enables the work spindles to rotate at speeds other than those which are dictated by available standard gear changes while, at the same time, retaining the full range of torque values that are afforded by those gear trains. The adaptation made permits the constant and selective variation of spindle speeds to increments as small as one revolution per minute (1 rpm); and through the incorporation of a digital incremental encoder on the main drive shaft, it also permits immediate confirmation that such precise speed regulation has been achieved.

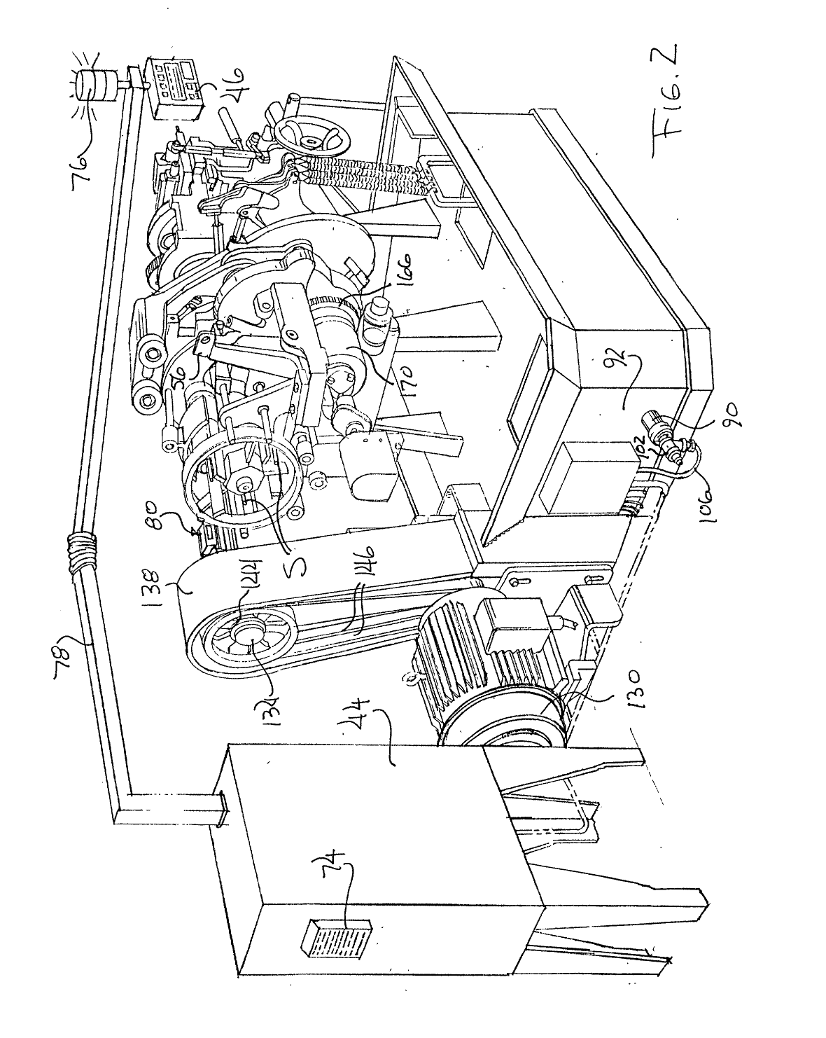

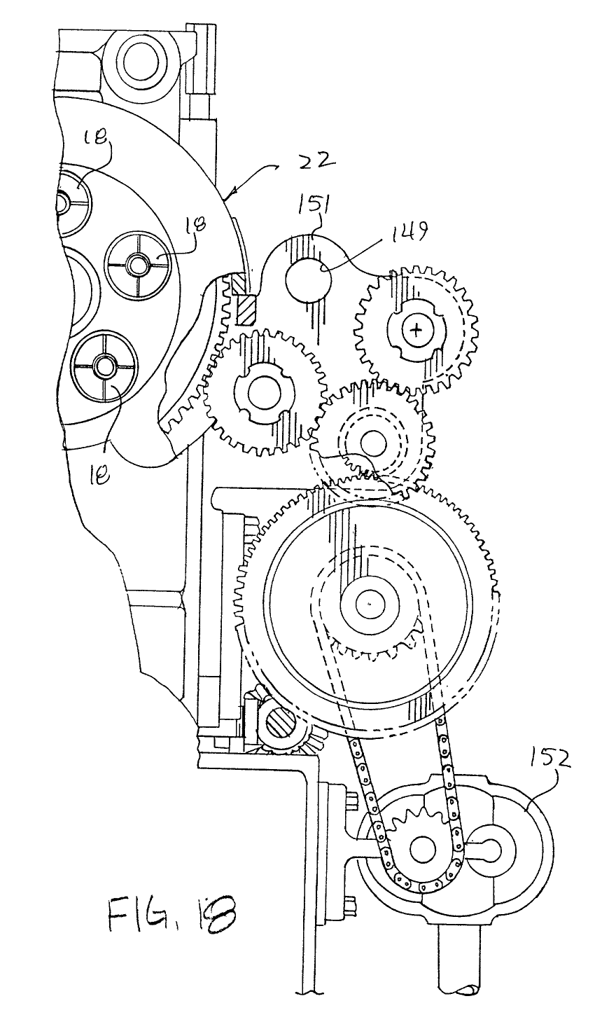

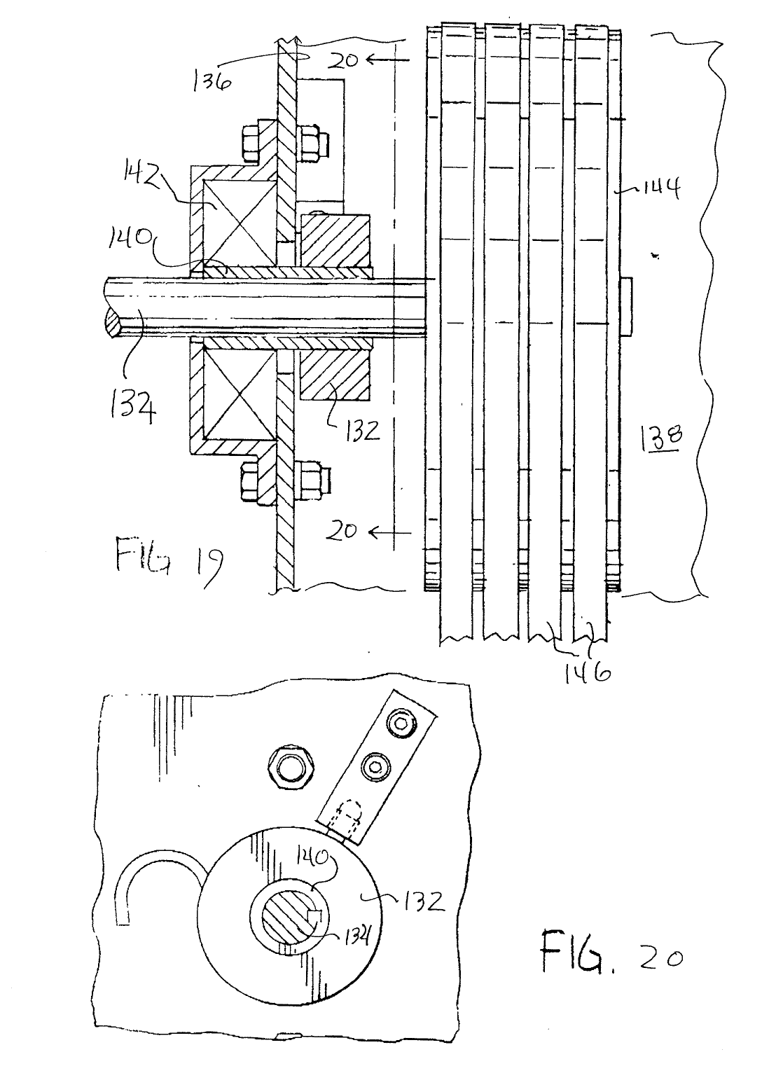

More particularly, and as is seen in FIGS. 2 and 17 through 20, an inverter duty motor 130 is substituted as the main drive motor of the machine, and a hollow shaft encoder 132, mounted on an adaptor bushing 140 received within a bearing 142, is installed over the main drive shaft 134. The driven pulley 144 on the shaft 134, and the drive belts 146 from the motor 130, are enclosed within a belt housing, generally designated by the numeral 138, within which the encoder 132 is also protectively enclosed, adjacent the housing wall 136. As will be appreciated, the encoder 132 provides a feedback signal to the controller that is indicative of the speed of rotation of the main drive shaft 134, thereby enabling not only the desired close control of the shaft speed but also reliable, selective variation even within portions of the cycle of operation; i.e., as apportioned between the so-called work phase and idle phase of each cycle (each typically constituting 50% of the cycle). In addition, where long cycle times are involved the speed of spindle rotation can be varied during the cycle to effectively improve material cutting or shaping efficiency and also to reduce the overall time required.

As noted above, moreover, this adaptation maintains the spindle change gears 148 and 150 (FIG. 17) operative in the drive train (the aperture 149 in the support 151 served to receive the threading shaft of the conventional machine). The modified machine utilizes the variable speed motor in combination with those change gears (the latter for making gross variations) for rotating the work-holding spindles at virtually any speed throughout defined ranges, while maintaining the designed torque values of the machine; this is therefore a unique and highly beneficial modification. Thus, with minimal input from the operator, a long-run job can be carried out using a standard optimal gear ratio, requiring the motor to operate at its base (or design) speed, which need be adjusted, or overridden, by only a small percentage. It is also to be noted that the standard driven lubricant pump 152 can be retained in its normal position while incorporating the work spindle axis drive adaptation described, whereas previous approaches required modification or replacement of the standard pump so as to accommodate the alternative motors that were deemed to be necessary.

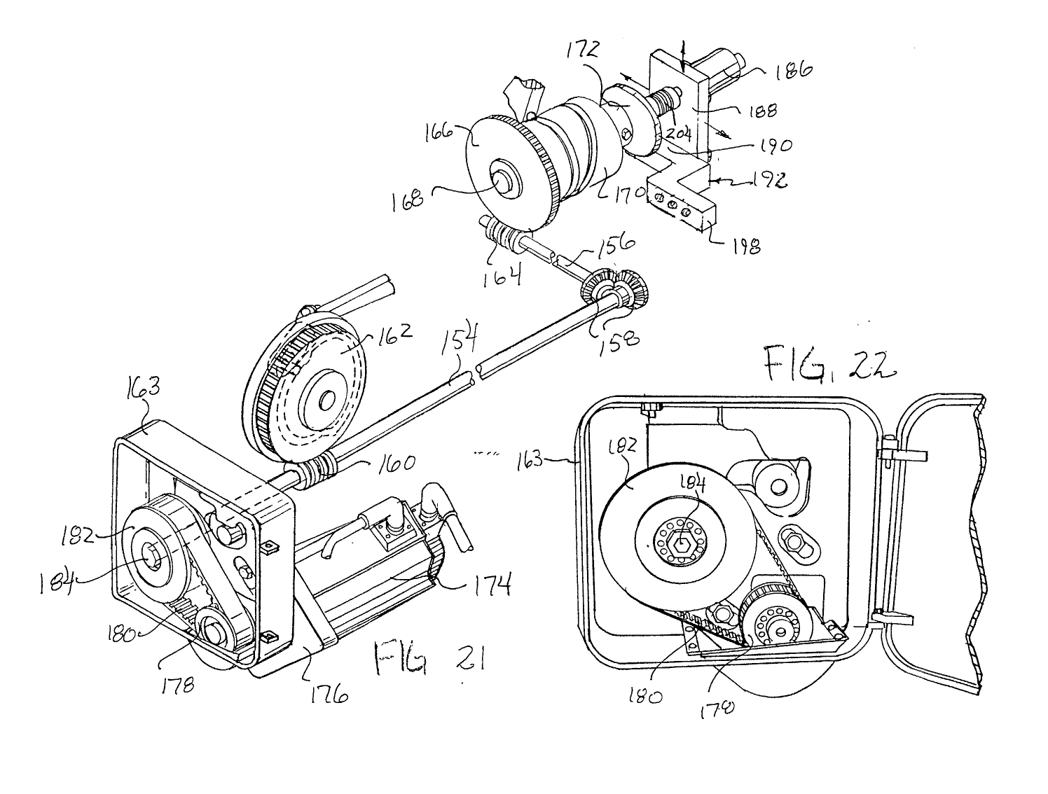

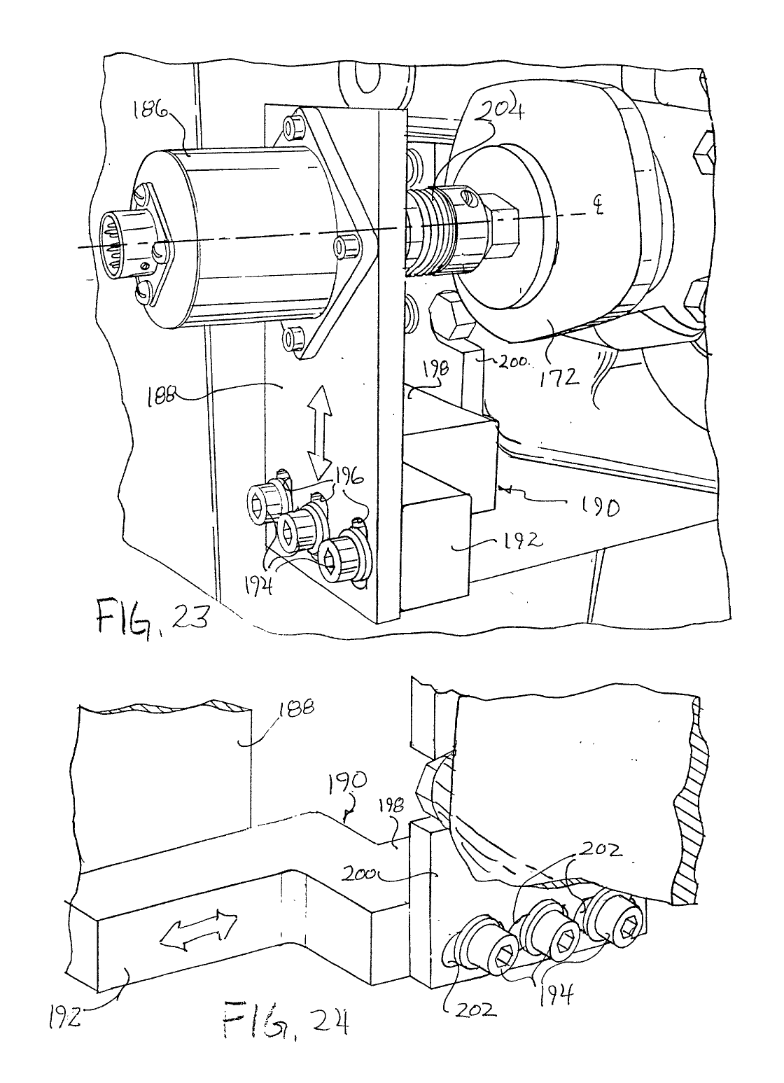

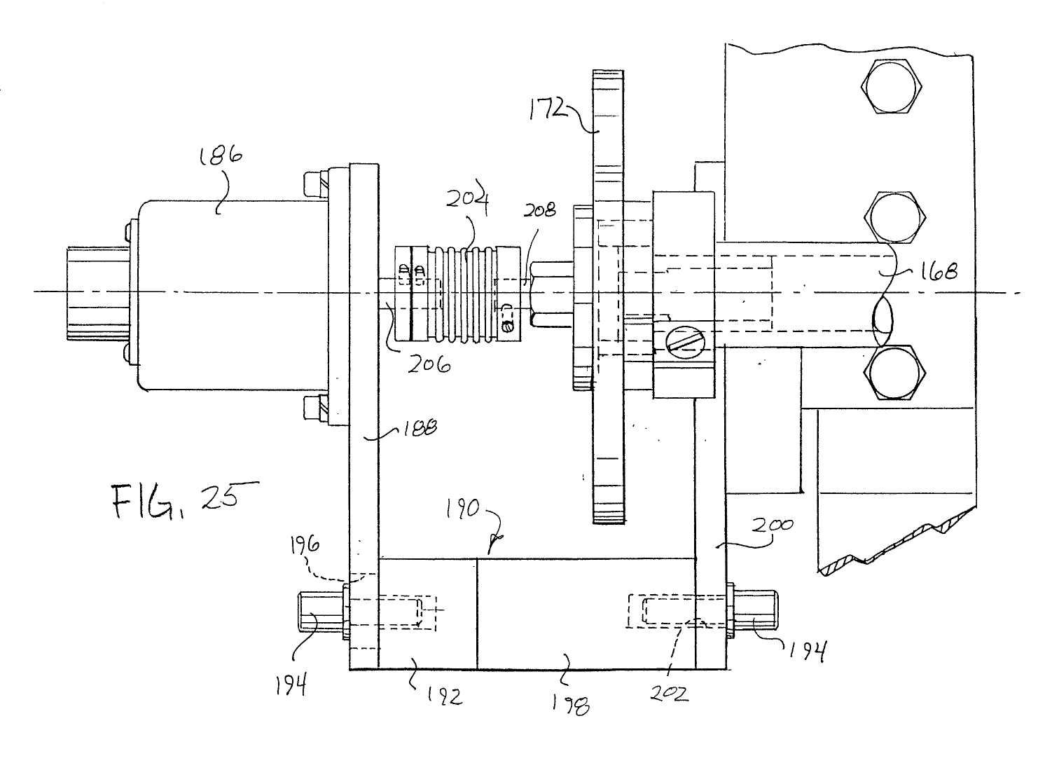

Finally, and as is depicted in FIGS. 21 through 25 of the drawings, adaptations are made in accordance with the present invention for improving the capacity and performance of the Davenport machine cam axis drive. The standard cam axis drive 30 includes a longitudinal drive shaft 154 and a transverse drive shaft 156, which are coupled through bevel gears 158. The longitudinal shaft 154 carries a worm gear 160, which is in meshing engagement with a worm wheel 162, and the transverse shaft 156 carries a worm gear 164 which engages the worm wheel 166, mounted on a shaft 168 lying parallel to the shaft 154. Also affixed to the shaft 168 is a barrel cam 170 and a lobe cam 172 the latter serving for declutching of spindles through a cooperating lever.

A variable speed servomotor 174 is, in accordance with the present adaptation, attached to a mounting plate 176, the plate in turn being bolted to the rear of the existing gear box casting 163 (shown with its door removed, in this Figure), utilizing the holes already present therein. A timing pulley 178 is mounted within the gear box on the shaft of the motor 174, and serves to drive, through a belt 180, a second pulley 182 operatively mounted on the cam shaft 154, an extension 184 being attached to the shaft 154 however to enable the present modifications (which effectively replace the overrunning clutch and feed gears that are standard in a Davenport machine).

An encoder 186, for providing position signals to the controller 44, is disposed at the opposite end of the machine (normally contained within an enclosure). To facilitate alignment of the encoder 186, while providing adequate space for the cam 172 (which is a common, albeit not standard, desired attachment to the machine), a mounting assembly is provided which constitutes a plate 188 and an offsetting bracket, generally designated by the numeral 190.

As can be seen in the several figures, the encoder 186 is bolted adjacent the upper end of the plate 188. Three vertically elongated slots 196 are formed through the lower portion of the plate 188, and serve to receive bolts 194 which are threadably engaged in apertures (not seen) formed in the forward arm 192 of the bracket 190, thereby, affording vertical adjustability of the plate 188 on the bracket 190. The rearward arm 198 of the bracket 190 is also formed with three threaded apertures (not seen), which receive bolts 194 that pass through a plate 200, which is in turn bolted to the frame of the machine and in which three horizontally elongated slots 202 are formed; accordingly, the bracket 190, and hence the plate 188 and mounted encoder 186, is transversely adjustable as well. Thus, the ability to vary the position of the plate 188 in two parallel planes readily enables accurate alignment of the centerline of the encoder 186 with the shaft 168, and the offset of the bracket provides the space necessary for receiving an attachment such as declutching cam 172. As best seen in FIG. 25, a coupling 204 joins the shaft 206 of the encoder 186 to the stub axle 208, which is in turn operatively affixed to the shaft 168.

The present cam axis drive adaptation removes many standard mechanical components from the Davenport machine while, at the same time, retaining the fundamental concept of a cam-driven machine. It uses an electromechanical servo system and controller to accomplish the synchronization and orchestration of a main drive shaft cam, rendering unnecessary certain components and reducing the complexity of the machine, and its control; moreover this adaptation does not change the overall look, fit, and function of the machine. No major changes or additions are necessary to the frame or to its attached components; the servomotor mount is inconspicuously disposed within the existing footprint, and its readily mounted by the use of simple spacers, thereby enabling (as previously noted) the original gearbox to be retained. Axis position feedback is provided by an accurately and rigidly mounted, closely coupled absolute position feedback encoder, which enables the controller to determine the precise position of the cam axis at all times, and the encoder is readily positioned directly on the drive line, so as to thereby maximize its accuracy and utility.

Thus, it can be seen that the present invention provides novel sensor arrangements by which the safety of operation and the productivity of an automatic machine, and in particular an automatic multiple spindle screw machine, can be enhanced and increased. The sensor arrangements function to ensure safe indexing of the revolving head of such a machine; they serve to maximize productivity by monitoring workpiece stock loading and feed mechanisms operation, and they ensure the maintenance of adequate levels of the coolant/lubricant liquid. The invention also provides novel axis drive adaptations in multiple spindle automatic screw machines and, in particular, threading axis drive, work spindle axis drive, and cam axis drive adaptations.

Having thus described the invention, what is claimed is:

1. In a multiple spindle automatic screw machine having electronically controlled functions, said machine including a frame; electronic control means; a stationary head, and a revolving head having work spindles; a burring spindle mounted for axial reciprocation in said stationary head for removing shaped parts from work spindles mounted in said revolving head; feed tubes in said revolving head; means for advancing stock through said feed tubes, including a reciprocating chuck slide, a chuck slide opening guide pivotably mounted for movement between positions engaged with and disengaged from said chuck slide, and a chuck slide opening cam lever disposed adjacent said chuck slide opening guide; and a tank, for containing a reservoir of liquid, defined by a lateral wall of said machine; the improvement comprising:
a first sensor operatively mounted on said frame of said machine adjacent said burring spindle for movement throughout a range of selectively fixed positions therealong, said first sensor being constructed for generating a first signal indicative of the proximity of an activating element and being operatively connected for transmitting said first signal to said electronic control means; and an activating element disposed on said burring spindle at such a location as to enable it to come into activating proximity to said first sensor, disposed in an effective position, immediately upon retraction of said burring spindle from a forward position adjacent a work spindle in said revolving head, such that said first signal indicates that said revolving head can safely be indexed;
a second sensor mounted upon one of said chuck slide opening guide and said chuck slide opening cam lever of said stock-advancing means, and being constructed and positioned for generating a second signal indicative of the proximity of the other of said chuck slide opening guide and said chuck slide opening cam lever, said second sensor being operatively connected for transmitting said second signal to said electronic control means for indicating that stock is being advanced through said feed tubes;
a third sensor operatively mounted upon said frame of said machine adjacent inlet ends of said feed tubes and being constructed and positioned for generating a third signal indicative of the presence of stock extending from said feed tube inlet ends, said third sensor being operatively connected for transmitting said third signal to said electronic control means for indicating that stock is becoming exhausted in said feed tubes;
alarm means responsive to at least one of said second signal and said third signal; and
an outwardly disposed extension in liquid flow communication with said tank through said lateral wall of said machine and defining an auxiliary chamber of small volume; and a liquid level sensor disposed within said auxiliary chamber entirely outwardly of said wall, said liquid level sensor being constructed for generating a fourth signal indicative of the depletion of liquid in said tank.

2. In a multiple spindle automatic screw machine having electronically controlled functions, said machine including a frame; electronic control means; a stationary head, and a revolving head having work spindles; and a burring spindle mounted for axial reciprocation in said stationary head for removing shaped parts from work spindles mounted in said revolving head; the improvement comprising:
a sensor operatively mounted upon said frame of said machine adjacent said burring spindle for movement throughout a range of selectively fixed positions therealong, said sensor being constructed for generating a signal indicative of the proximity of an activating element and being operatively connected for transmitting said signal to said electronic control means; and an activating element disposed on said burring spindle at such a location as to enable it to come into activating proximity to said sensor, disposed in an effective position, immediately upon retraction of said burring spindle from a forward position adjacent a work spindle in said revolving head, such that said signal indicates that said revolving head can safely be indexed.

3. The machine of claim 2 wherein said sensor functions magnetically and said activating element is constructed to induce current flow therein.

4. The machine of claim 3 wherein said activating element comprises a ring of ferromagnetic material operatively affixed coaxially on said burring spindle in surrounding relationship thereto.

5. The machine of claim 4 wherein said burring spindle has a gear affixed coaxially thereon for receiving driving power for effecting rotation thereof, and wherein said ring of ferromagnetic material has at least one well-defined circumferential edge and is affixed directly to said gear with said circumferential edge disposed forwardly thereof for magnetic interaction with said sensor.

6. The machine of claim 2 additionally including a way affixed on said frame and defining a track that extends adjacent and parallel to said axis of said burring spindle, and a saddle mounted upon said way for slidable movement along said track, said saddle carrying said sensor and having means thereon for affixing it in selected positions along said way.

7. The machine of claim 2 wherein said sensor has associated visual indicator means for indicating when said sensor is activated by said activating element, said indicator means thereby facilitating the determination of an effective position for said sensor.

8. In a multiple spindle automatic screw machine having electronically controlled functions, said machine including a frame; electronic control means; a stationary head, and a revolving head having work spindles; feed tubes in said revolving head; and means for advancing stock through said feed tubes, including a reciprocating chuck slide, a chuck slide opening guide pivotably mounted for movement between positions engaged with and disengaged from said chuck slide, and a chuck slide opening cam lever disposed adjacent said chuck slide opening guide; the improvement comprising:
a sensor mounted upon one of said chuck slide opening guide and said chuck slide opening cam lever of said stock-advancing means, and being constructed and positioned for generating a signal indicative of the proximity of the other of said chuck slide opening guide and said chuck slide opening cam lever, said sensor being operatively connected for transmitting said signal to said electronic control means for indicating that stock is being advanced through said feed tubes.

9. The machine of claim 8 wherein said sensor is mounted upon said chuck slide opening cam lever.

10. The machine of claim 9 wherein said chuck slide opening cam lever and said chuck slide opening guide have mating surfaces that lie in face-to-face contact when said chuck slide opening guide is in said position of engagement with said chuck slide, and wherein said sensor has a functional end lying substantially on said mating surface of said chuck slide opening cam lever and serves to sense the proximity of said mating surface of said chuck slide opening guide.

11. The machine of claim 10 wherein said sensor functions magnetically and said mating surface of said chuck slide opening guide serves to induce current flow therein.

12. In a multiple spindle automatic screw machine having electronically controlled functions, said machine including a frame; electronic control means; a stationary head, and a revolving head having work spindles; electronic control means; feed tubes in said revolving head; and means for advancing stock through said feed tubes; the improvement comprising:
a sensor operatively mounted on said frame of said machine adjacent intake ends of said feed tubes and being constructed and positioned for generating a signal indicative of the presence of stock extending from said feed tube intake ends, said third sensor being operatively connected for transmitting said signal to said electronic control means for indicating that stock is becoming exhausted in said feed tubes.

13. The machine of claim 12 wherein said sensor is an optical sensor.

14. The machine of claim 12 wherein said electronic control means is constructed to enable the determination of decrementation values, and thereby to indicate an exhausted stock condition based upon input stock length and utilization data, and machine feed requirements.

15. In a multiple spindle automatic screw machine having electronically controlled functions, said machine including a frame; electronic control means; a stationary head, and a revolving head having work spindles; feed tubes in said revolving head; and means for advancing stock through said feed tubes, including a reciprocating chuck slide, a chuck slide opening guide pivotably mounted for movement between positions engaged with and disengaged from said chuck slide, and a chuck slide opening cam lever disposed adjacent said chuck slide opening guide; the improvement comprising:
one sensor, mounted upon one of said chuck slide opening guide and said chuck slide opening cam lever of said stock-advancing means and being constructed and positioned for generating a signal indicative of the proximity of the other of said chuck slide opening guide and said chuck slide opening cam lever, said one sensor being operatively connected for transmitting the proximity-indicating signal to said electronic control means for indicating that stock is being advanced through said feed tubes; and
another sensor, operatively mounted upon said frame of said machine adjacent intake ends of said feed tubes and being constructed and positioned for generating a signal indicative of the presence of stock extending from said feed tube intake ends, said another sensor being operatively connected for transmitting said stock presence-indicating signal to said electronic control means for indicating that stock is becoming exhausted in said feed tubes;
said electronic control means being constructed to enable the determination of decrementation values, and thereby to indicate an exhausted stock condition based upon said stock presence-indicating signal from said another sensor, and being constructed to effect such a determination of decrementation values subject to said proximity-indicating signal from said one sensor indicating that stock is being advanced through said feed tubes.

16. The machine of claim 15 additionally including alarm means operatively connected to said electronic control means, said electronic control means being constructed to activate said alarm means when at least one of said proximity-indicating signal and said stock presence-indicating signal indicates, respectively, that stock is not being advanced through said feed tubes and that stock in at least one of said feed tubes has become exhausted.

17. In a multiple spindle automatic screw machine having electronically controlled functions, said machine including electronic control means and a tank for containing a reservoir of liquid, said tank being defined by a lateral wall; the improvement comprising:
an outwardly disposed extension in liquid flow communication with said tank through said lateral wall and defining an auxiliary chamber of small volume; and a liquid level sensor disposed within said auxiliary chamber entirely outwardly of said wall, said liquid level sensor being constructed for generating a signal indicative of the depletion of liquid in said tank, and being operatively connected for transmitting said liquid-depletion signal to said electronic control means.

18. The machine of claim 1 wherein said electronic control means comprises digital electronic data processing means.

19. The machine of claim 2 wherein said electronic control means comprises digital electronic data processing means.

20. The machine of claim 8 wherein said electronic control means comprises digital electronic data processing means.

21. The machine of claim 12 wherein said electronic control means comprises digital electronic data processing means.

22. The machine of claim 15 wherein said electronic control means comprises digital electronic data processing means.

23. The machine of claim 17 wherein said electronic control means comprises digital electronic data processing means.
